(19) United States
(12) Patent Application Publication
(10) Pub. No.: US 2018/0081435 A1
(43) Pub. Date: Mar. 22, 2018

(54) SOMATOSENSORY CONTROL WRISTBAND

(71) Applicant: Meta Technologies Inc., Irvine, CA (US)

(72) Inventor: Weixun MA, Zheji-ang (CN)

(21) Appl. No.: 15/565,649

(22) PCT Filed: Apr. 18, 2016
(86) PCT No.: PCT/CN2016/079536

§ 371 Date: Oct. 10, 2017

(30) Foreign Application Priority Data
Apr. 17, 2015 (CN) 201520233682.0

(51) Int. Cl. G06F 3/01; G08C 17/02

(52) U.S. Cl. CPC G06F 3/014; G08C 2201/32; G06F 3/017; G08C 17/02

(57) ABSTRACT

A somatosensory control wristband is provided. The somatosensory control wristband includes a somatosensory control device and a wristband strap. The wristband strap includes a first strap, a wristband strap body, and a second strap. The wristband strap body has an accommodating space with an opening, and the somatosensory control device is detachable accommodated in the accommodating space.

### TECHNOLOGY FIELD

The present invention relates to a somatosensory control wristband, and particularly to a somatosensory control wristband which enhances human-computer interaction.

### BACKGROUND

Human-computer interaction technology, such as somatosensory games, becomes people's favorite because of its fitness and entertainment. At present, the human-computer interaction technology is usually achieved by a somatosensory control device connected with a television set, a set-top box, or the like by a camera or a game controller. Therefore the somatosensory control device can only interact with the television set in a very limited range. Thus the scope of people's activities is limited, and the somatosensory interaction is also limited. On the other hand, the traditional somatosensory control device of the prior art is directly integrated into the game handle or wristband, and cannot be separated. Thus while the wristband is damaged, the entire wristband cannot be normally used. Then the lifespan of the wristband is limited, the sense of reality is also affected.

### SUMMARY

Therefore, it is necessary to provide a somatosensory control wristband can improve sense of reality in the process of human-computer interaction.

A somatosensory control wristband comprising a wristband strap and a somatosensory control device, wherein the wristband strap comprises a first strap, a wristband strap body, and a second strap. The wristband strap body defines an accommodating space, and the somatosensory control device is accommodated in the accommodating space. The accommodating space defines an opening, and the somatosensory control device is detachable accommodated in the accommodating space through the opening.

The first strap, the wristband strap body, and the second strap are connected in that sequence to form an integrated structure.

The wristband strap body is bent from the middle position to the tow opposite sides of the wristband strap body to form a curved structure.

The thickness of the wristband strap body is greater than the thickness of the first strap and the second strap, and the thickness of both the first strap and second strap is gradually reduced in a direction away from the wristband strap body.

The wristband strap comprises an inner surface and an outer surface. The opening is formed on the inner surface, and a plurality of patterns is formed on the outer surface.

The wristband strap body extends from a periphery of the opening toward a center of the opening to form a fixed frame, and the somatosensory control device is accommodated and fixed in the accommodating space.

The first strap has a buckle at one end of the first wristband away from the wristband strap body, and the second strap wristband has a plurality of through holes for matching with the buckle.

The wristband strap body comprises a plurality of button protrusions to accommodate buttons protruded from the surface of the somatosensory control device.

The wristband strap comprises two layers of silicone material compounded to form a composite structure.

The somatosensory control device comprises a power supply module, a gesture sensing module, and a transmission module. The power supply module is respectively electrically connected with the gesture sensing module and the transmission module to provide power. The gesture sensing module is configured to sense the gesture and convert the gesture to a gesture data. The transmission module is adapted to receive the gesture data, and transfer the gesture data. The gesture sensing module comprises a gesture sensor and a gesture data processor encapsulated in the same chip. The gesture data processor processes gesture information sensed by the gesture sensor and converts it into the gesture data. The transmission module comprises a data transmission unit and a transmission control unit packaged in the same chip. The transmission control unit is used to control the data transmission unit to receive and transmit the gesture data.

Compared with the traditional somatosensory control device, the somatosensory control wristband provided by the invention the gesture data sensed by the gesture sensor is processed by the gesture data processor. Thus the processing ability of the data is greatly improved, and more gesture data can be processed. Therefore, the delay during data processing can be reduced, the sensitivity of somatosensory control devices can be improved, and the sense of reality in the interaction can be improved.

### BRIEF DESCRIPTION OF THE DRAWINGS

FIG. 1 shows a schematic view of one embodiment of a somatosensory control wristband.

FIG. 2 shows a schematic view of one embodiment of a wristband strap.

FIG. 3 shows a schematic view of one embodiment of a somatosensory control device.

FIG. 4 shows a schematic structure view of one embodiment of a somatosensory control device.

### SYMBOL DESCRIPTION

TABLE 1

| | | | |
|---|---|---|---|
| somatosensory control wristband | 100 | gesture sensing module | 11 |
| somatosensory control device | 110 | transmission module | 12 |
| wristband strap | 120 | vibrator | 13 |
| wristband strap body | 124 | light emitting unit | 14 |
| first strap | 125 | communication unit | 15 |
| second strap | 126 | USB port | 16 |
| accommodating space | 1241 | battery unit | 101 |
| opening | 1242 | charging circuit | 102 |
| fixed frame | 1243 | power management unit | 103 |
| button protrusion | 1245 | gesture sensor | 111 |
| buckle | 1251 | gesture data processor | 112 |
| through hole | 1261 | data transmission unit | 121 |
| shell | 20 | transmission control unit | 122 |
| power supply module | 10 | data storage unit | 123 |

The present invention will be further illustrated by the following detailed description with the accompanying drawings.

### DETAILED DESCRIPTION

The somatosensory control wristband in the present invention will be described in further detail below accompanying drawings and specific examples.

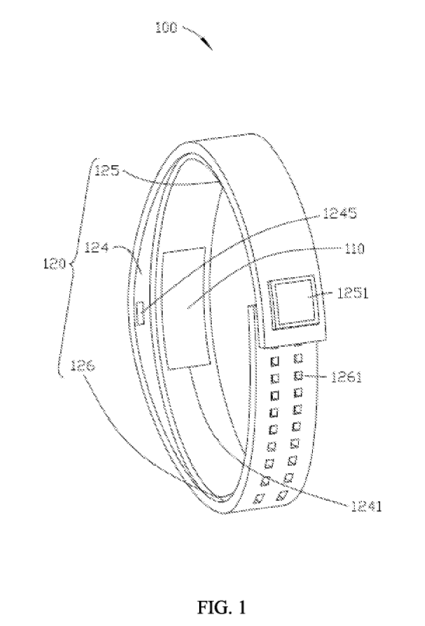

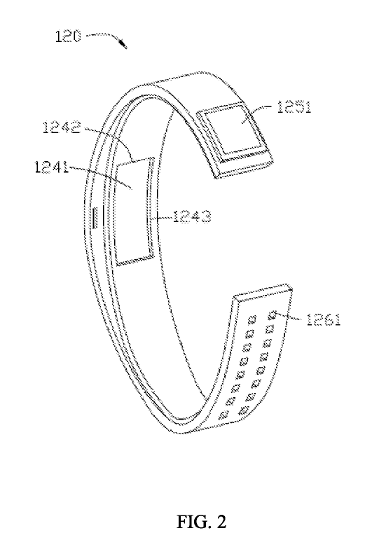

Referring to FIGS. 1-2, one embodiment of a somatosensory control wristband 100 comprising a somatosensory control device 110 and a wristband strap 120, wherein the somatosensory control device 110 is detachably accommodated in the wristband strap 120.

In one embodiment, the wristband strap 120 has an accommodating space 1241, and the somatosensory control device 110 can be detachably accommodated in the accommodating space 1241. The wristband strap 120 can be worn on a wrist of a user, such as surrounded on the wrist. The wristband strap 120 is in a shape of half-ring wristband, and has an opening. The wrist can be inserted into the wristband strap 120 through the opening. Then the opening can be closed to form a closed wristband. The wristband strap 120 comprises a wristband strap body 124 between a first strap 125 and a second strap 126. The first strap 125, the wristband strap body 124, and the second strap 126 are joined together to form an integral structure. The thickness of the wristband strap body 124 is greater than the thickness of the first strap 125 and second strap 126. Furthermore, the thickness of the wristband strap body 124 is greater than the thickness of the somatosensory control device 110, so that the somatosensory control device 110 can be fully accommodated in the wristband strap body 124. The wristband strap body 124 can have a thickness of 8 mm to 10 mm, a width of 15 mm to 25 mm, and a length of 35 mm to 45 mm. In one embodiment, the wristband strap body 124 has a thickness of 9 mm, a width of 20 mm, and a length of 40 mm. The wristband strap body 124 forms an arc in a direction extending from the middle position to both sides. Thus the wristband strap body 124 forms a curved structure, and the wearing comfort can be improved. The curvature of the wristband strap body 124 can be selected according to need. Furthermore, the thickness of both the first strap 125 and the second strap 126 is gradually reduced in the direction away from the wristband strap body 124.

The wristband strap 120 comprises an inner surface and an outer surface. The inner surface is close to the surface of the wrist while the wristband strap 120 is worn, and the outer surface is a surface away from the surface of the wrist. The inner surface can be a smooth surface to increase the wearing comfort, and a plurality of patterns may be distributed on the outer surface. Thus the aesthetics of the wristband strap 120 can be improved. In one embodiment, the outer surface forms a plurality of square recesses, and the plurality of square recesses can be semi-transparent. Thus the light emitted from the somatosensory control device 110 can be transmitted. The inner surface and the outer surface are curved surfaces at a natural state, so that the wrist can be more easily fitted. Furthermore, at the connection between the first hand band 125, and connection between the second strap 126 and the wristband strap body 124, the curvature (i.e., the degree of bending) of the outer surface is greater than the curvature of the inner surface. The first strap 125 and the second strap 126 can extend closer to each other at the natural state.

The wristband strap body 124 has the accommodating space 1241 for receiving the somatosensory control device 110, and the shape of the accommodating space 1241 can be selected in accordance with the shape of the somatosensory control device 110. The accommodating space 1241 can be a half-closed structure. The accommodating space 1241 is a space extend from the outer surface into the inner surface of the wristband strap 120, and an opening 1242 is formed on the inner surface of the wristband strap 120. Other surfaces of the accommodating space 1241 are formed in the wristband strap body 124. Furthermore, a portion of the wristband strap body 124 extends from the periphery of the opening 1242 toward the center of the opening 1242 to form a fixed frame 1243. The fixed frame 1243 is configured to receive and secure the somatosensory control device 110 within the accommodating space 1241. The width of the fixed frame 1243 can range from about 1 mm to about 5 mm, and can be selected according to the size of the somatosensory control device 110 to facilitate loading and unloading of the somatosensory control device 110. In one embodiment, the width of the fixed frame 1243 is about 2 mm. The accommodating space 1241 is smaller than the wristband strap body 124. The depth of the accommodating space 1241 can range from about 6 mm to about 9 mm, the width of the accommodating space 1241 is about 13 mm to about 23 mm, and the length of the accommodating space 1241 is about 33 mm to about 43 mm. In one embodiment, the depth of the accommodating space 1241 is about 8 mm, the width is about 18 mm, and the length is about 39 mm.

Furthermore, the wristband strap body 124 may have a plurality of button projections 1245 for receiving buttons protruded on the surface of the somatosensory control device 110, and the somatosensory control device 110 can be controlled by touching the plurality of button projections 1245. The distribution of the plurality of button projections 1245 can be selected in accordance with the buttons on the surface of the somatosensory control device 110.

The first strap 125 is located at one end of the wristband strap body 124, and a buckle 1251 is located at the end of the first strap 125 away from the wristband strap body 124. A plurality of through holes 1261 can be distributed on the second strap 126 to match the buckle 1251. Each through hole 1261 can be matched with the buckle 1251 so as to open and close the wristband strap 120. The plurality of through holes 1261 are evenly distributed on the surface of the second strap 126, thus the somatosensory control wristband 100 can be easily adjusted according to the thickness of the different user's wrist. In one embodiment, the buckle 1251 has a pin, and the buckle 1251 is detachably secured to the first strap 125 through the pin. Furthermore, the pin passes through the first strap 125 along the thickness direction, and serves to secure the buckle 1251 with the through holes 1261 to close and open the wristband strap 120.

Furthermore, the first strap 125 and the second strap 126 can be fastened through a galling or a magnet.

The material of the wristband strap 120 can be a flexible material. The flexible material can be an opaque, transparent, or translucent, such as rubber, silicone or elastomeric plastic. In one embodiment, the material of the wristband strap 120 is a medical grade silicone material, thus the wearing comfort can be improved. Furthermore, the wristband strap 120 can be a composite structure comprising two different colored silicone materials, in order to form a double layer structure. Thus the accommodating space 1241 can be facilitated formed by compounding the two different silicone materials.

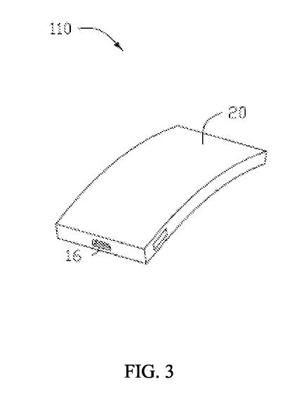

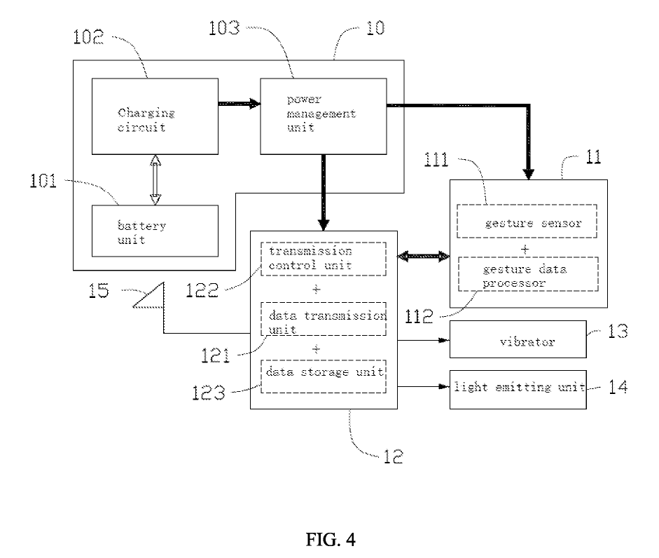

Referring to FIGS. 3-4, the somatosensory control device 110 is accommodated in and tightly engaged with the accommodating space 1241 and fixed in the accommodating space 1241. The shape of the somatosensory control device 110 can be selected in accordance with the accommodating space 1241. In one embodiment, the somatosensory control device 110 is a cuboid structure. Furthermore, the somatosensory control device 110 is gradually bent from the middle position toward both the two opposite sides along the length direction to form a curved structure, thereby the cooperation and the comfort can be improved at the time of wearing.

The somatosensory control device 110 comprises a power supply module 10, a gesture sensing module 11, and a transmission module 12 sealed in a shell 20. The power supply module 10 is connected to the gesture sensing module 11 and the transmission module 12 to supply power. The power supply module 10 comprises a battery unit 101, a charging circuit 102, and a power management unit 103. The battery unit 101 is electrically connected to the power management unit 103 through the charging circuit 102. The power is supplied to the gesture sensing module 11 and the transmission module 12 through the power management unit 103 respectively. The battery unit 101 may be a coin cell having a charging characteristic or without charging characteristic. The battery unit 101 may be a lithium battery or an alkaline battery with charging characteristic or without charging characteristic. In one embodiment, the battery unit 101 is a rechargeable lithium battery having a capacity of 130 mAh. The power management unit 103 may include a plurality of power consumption modes to control the battery unit 101 to switch between different power modes, depending on the environment and different needs to prolong the use time of the battery unit 101.

The gesture sensing module 11 comprises a gesture sensor 111 and a gesture data processor (MCU) 112 encapsulated in the same chip, and connected to the power supply module 10. The gesture sensor 111 may be a nine-axis sensor comprising a tri-axial gravity sensor, a tri-axial gyroscope sensor, and a tri-axial geomagnetic sensor for monitoring various motion states of the human body or other objects. The motion information sensed by the gesture sensor 111 is input into the gesture data processor 112. Specifically, the tri-axial gravity sensor is used to sense gravity information, generate a gravitational acceleration signal and transmit it to the gesture data processor 112 for processing. The tri-axial gyroscope sensor is an angular motion detecting device to sense angular velocity, convert the sensed angular velocity into an electrical signal, acquire the angular velocity information, and transfer the angular velocity information to the gesture data processor 112. The tri-axial geomagnetic sensor is used to acquire the direction information, i.e., the magnetic field vector information. The magnetic field vector information is transferred to the gesture data processor 112. Furthermore, the sensing time of the gesture sensor 111 sensing the motion state is less than 20 milliseconds. Thus, the processing rate of the gesture information processed by the gesture sensor module 11 to is 50 groups/second. Therefore the delay can be effectively reduced, and more data can be transferred and processed.

The gesture data processor 112 is configured to initially process and integrate the gesture data acquired by the gesture sensor 111, and converts the gesture data into absolute data such as absolute acceleration, absolute angular velocity, and absolute direction respect to the ground. The absolute acceleration, the absolute angular velocity, and the absolute direction can be transmitted to the transmission module 12. In particular, the gesture data processor 112 integrates, analyzes, and converts the large amount of data collected by the gesture sensor 111 into standard values for different applications or games.

The transmission module 12 comprises a data transmission unit 121 and a transmission control unit 122. Furthermore, the data transmission unit 121 and the transmission control unit 122 are encapsulated in the same chip. The data transmission unit 121 is configured to receive the gesture data output from the gesture sensing module 11, and transfer the gesture data to the other electronic apparatus to control the other electronic apparatus. The transmission control unit 122 is connected to control the data transmission transferred by the data transmission unit 121. The data transmission unit 121 can be a wireless module, an infrared module, or a Bluetooth module. In one embodiment, the data transmission unit 121 is a low power Bluetooth module (BLE), and is compatible with the Bluetooth (BT) specification. Thus the data transmission unit 121 can be adapted to connect with different electronic devices to transmit data.

Furthermore, the transmission module 12 comprises a data storage unit 123 connected to the data transmission unit 121 and the transmission control unit 122. The data storage unit 123 is used to store the data transferred from the gesture sensing module 11. The data transmission unit 121 can read data from the data storage 121 according to different instructions under the control of the transmission control unit 122. In one embodiment, the data storage unit 123 is a flash ram.

Furthermore, the somatosensory control device 110 can include a vibrator 13 for generating vibrations while receiving a signal. While the vibrator 13 receives the specific signal transmitted by the gesture sensor module 11, the vibrator 13 can generate vibrations to remind the user, and enhance the realistic feeling of the human-computer interaction in the interactive process.

Furthermore, the somatosensory control device 110 can comprise a light emitting unit 14 electrically connected to the gesture sensing module 11 and the transmission module 12. The light emitting unit 14 is capable of emitting light, flashing, and instructing power under the control of the gesture data processor 112 and the transmission control unit 122. In one embodiment, the light emitting unit 14 is a variable color LED lamp.

Furthermore, the somatosensory control device 110 may comprises a communication unit 15 connected to the data transmission unit 121. The communication unit 15 can transmit data between the somatosensory control device and other electronic devices, and the interaction between the somatosensory control device 110 and other electronic devices can be achieved. In one embodiment, the communication module 15 is a Bluetooth antenna.

The somatosensory control device 110 may further comprises a USB port 16 for charging, copying data, or transmitting data with other electronic devices. The USB port 16 may be disposed on either surface of the somatosensory control device 110. In one embodiment, the USB port 16 is a Micro-USB interface provided at one end of the somatosensory control device 110 in the length direction.

According to the present invention, the somatosensory control wristband has following advantages. First, the somatosensory control device is detachably embedded in the accommodating space by providing the accommodating space in the wristband, thus the somatosensory control device can be conveniently integrated in and separated from the wristband strap. Then the lifespan of the somatosensory control wristband can be prolonged. Second, it is convenient to replace the wristband strap with different colors according to needed without having to replace the somatosensory control device, thereby the population and beauty of the somatosensory control wristband can be improved. Third, the gesture data processor is dedicated to process the gesture data sensed by the gesture sensor, the transmission module and the transmission control unit is dedicated to transmit gesture data, thus the time delay during the data processing and transmission can be reduced, and more data can be transmitted to other device in a short time. Finally, by encapsulating the data transmission module, the transmission control unit and the storage module in the same chip, the overall power consumption can be greatly reduced, and the usage time of somatosensory control device can be prolonged.

In addition, those skilled in the art will also be able to make other changes within the spirit of the invention, and such changes that follow the spirit of the invention are intended to be included within the scope of the invention as claimed.

1. A motion control band comprising:
a wrist strap and a motion control device, the wrist strap comprising a first hand strap, a wrist strap body and a second hand strap, which are connected successively, wherein, the
wrist strap body has an accommodation space, the motion control device is received in the accommodation space, the accommodation space has an opening, the motion control device is detachable arranges in the accommodation space via the opening.

2. The motion control band according to claim 1, wherein the first hand strap,
the wrist strap body, and the second hand strap are seamlessly connected successfully, and are formed as a integrated structure.

3. The motion control band according to claim 2, wherein the wrist strap body bends upward towards an extension of the first hand strap and an extension of the second hand strap along the middle position respectively, to form a curve structure.

4. The motion control band according to claim 2, wherein a thickness of
the wrist strap body is greater than a thickness of the first and second hand strap, and the thickness of the first and second hand strap decreases gradually along a direction away from the wrist strap body.

5. The motion control band according to claim 1, wherein the wrist
strap comprises an internal surface and an external surface opposite to the internal surface, the opening is formed on the internal surface, the external surface has a plurality of patterns.

6. The motion control band according to of claim 5, wherein the
wrist strap body is extended from a periphery of the opening to a central of the opening at the opening to form a fixed border, so that the motion control device is received and fixed in the accommodation space.

7. The motion control band according to claim 1, wherein the first hand strap
has a block on an end far away from the wrist strap body, the second hand strap is provided with a plurality of holes fitted with the block.

8. The motion control band according to claim 1, wherein the wrist strap body comprises a plurality of button projections, to receive the raised button on the surface of the motion control device.

9. The motion control band according to claim 1, wherein the wrist
strap comprises two layers of silica gel materials, to form a composite structure.

10. The motion control band according to claim 1, wherein the motion control device comprises a power module, a posture sense module, and a transmission module; the power module is
connected to the posture sense module and the transmission module respectively to supply power; the posture sense module is used for sensing the status of movement, and transmitting the movement into a posture data; the transmission module is used for receiving posture output by the posture transmission module and forwarding; wherein, the posture sense module comprises a posture sensor and a posture data processor, which are encapsulated in a chip, the posture data processor processes posture information sensed by the posture sensor and transmits it into the posture data; the transmission module comprises a data transmission module and a transmission control module, which are encapsulated in a chip, the transmission control module is used for controlling the data transmission module to receive and transmit the posture data.
